(19) United States
(12) Patent Application Publication
(10) Pub. No.: US 2007/0296384 A1
(43) Pub. Date: Dec. 27, 2007

(54) Method of forming a feedback network and structure therefor

(75) Inventors: Stephen W. Dow, Austin, TX (US); David F. Moeller, Buda, TX (US); Praveen Manapragada, Round Rock, TX (US)

Correspondence Address: BRADLEY J. BOTSCH;SEMICONDUCTOR COMPONENTS INDUSTRIES, LLC, 5005 E. MCDOWELL ROAD, P.O.BOX 62890, INTELLECTUAL PROPERTY DEPT. - A700, PHOENIX, AZ, 85082, US

(73) Assignee: Semiconductor Components Industries, LLC.

(21) Appl. No.: 11/474,472

(22) Filed: Jun. 26, 2006

(51) Int. Cl. G05F 1/00

(52) U.S. Cl. 323/284

(57) ABSTRACT

In one embodiment, a feedback network of a voltage regulator is configured to adjust a value of a voltage divider responsively to a control word.

### CROSS-REFERENCE TO RELATED APPLICATIONS

This application is related to an application entitled “METHOD OF FORMING A PROGRAMMABLE VOLTAGE REGULATOR AND STRUCTURE THEREFOR” having inventors Brian Ballweber et al, having some common inventors, a common assignee, a docket number of ONS00756, and filed concurrently herewith which is hereby incorporated herein by reference.

### BACKGROUND OF THE INVENTION

The present invention relates, in general, to electronics, and more particularly, to methods of forming semiconductor devices and structure.

In the past, the semiconductor industry utilized various methods and structures to form voltage regulators that regulated an output voltage to a desired target value. The voltage regulator generally included some method to sense the value of the output voltage and an error amplifier that formed an error signal that was used to facilitate regulating the output voltage to the target value. The manufacturing process used to produce the voltage regulator generally had manufacturing tolerances that often varied the exact values of the components used in the voltage regulator circuit. These manufacturing variations resulted in undesirable variations in the value of the output voltage when the regulator was in operation.

Accordingly, it is desirable to have to a method of forming a voltage regulator structure that facilitates adjusting the voltage regulator to compensate for variations resulting from the process used to manufacture the voltage regulator and other variations that may affect the value of the output voltage.

### BRIEF DESCRIPTION OF THE DRAWINGS

FIG. 1 schematically illustrates an embodiment of a portion of a power supply system that includes a voltage regulator in accordance with the present invention; and

FIG. 2 schematically illustrates an enlarged plan view of a semiconductor device that includes a portion of the power system of FIG. 1 in accordance with the present invention.

For simplicity and clarity of the illustration, elements in the figures are not necessarily to scale, and the same reference numbers in different figures denote the same elements. Additionally, descriptions and details of well-known steps and elements are omitted for simplicity of the description. As used herein current carrying electrode means an element of a device that carries current through the device such as a source or a drain of an MOS transistor or an emitter or a collector of a bipolar transistor or a cathode or anode of a diode, and a control electrode means an element of the device that controls current through the device such as a gate of an MOS transistor or a base of a bipolar transistor. Although the devices are explained herein as certain N-channel or P-Channel devices, a person of ordinary skill in the art will appreciate that complementary devices are also possible in accordance with the present invention. It will be appreciated by those skilled in the art that the words during, while, and when as used herein are not exact terms that mean an action takes place instantly upon an initiating action but that there may be some small but reasonable delay, such as a propagation delay, between the reaction that is initiated by the initial action.

### DETAILED DESCRIPTION OF THE DRAWINGS

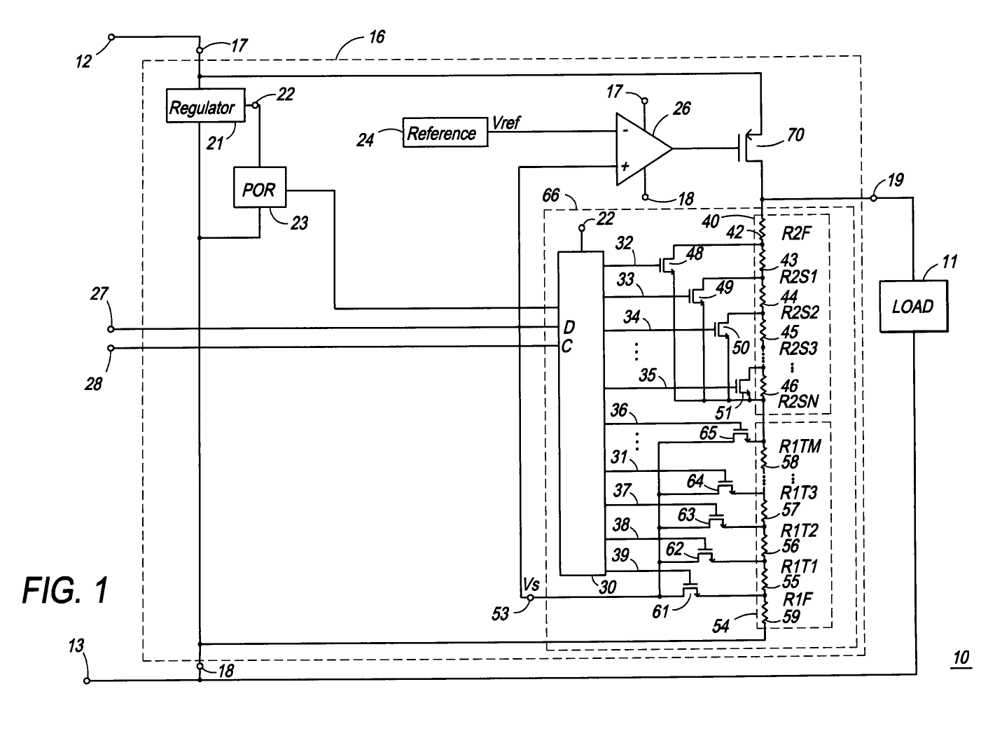

FIG. 1 schematically illustrates an embodiment of a portion of an exemplary form of a power supply system 10 that includes a linear voltage regulator 16. Regulator 16 includes a feedback network that can be adjusted after regulator 16 is manufactured and assembled into a semiconductor package. The adjustment facilitates compensating for variations in the elements of regulator 16, such as manufacturing variations in the values of the elements of regulator 16 and variations induced during the assembling of regulator 16 into a semiconductor package. System 10 generally receives power, such as a dc voltage, between a power input terminal 12 and a power return terminal 13 and supplies a regulated voltage to a load 11 that is connected to an output 19 of regulator 16.

Regulator 16 receives power between a voltage input 17 and a voltage return 18 that typically are connected to respective terminals 12 and 13. Regulator 16 usually includes a programmable feedback network 66 that forms a sense signal (Vs) on an output 53 that is representative of the value of the output voltage on output 19. The relationship between the sense signal (Vs) and the output voltage is adjustable due to the programmability of network 66. Regulator 16 also includes an error amplifier 26, a power-on reset circuit or POR 23, and a reference generator or reference 24. Reference 24 may be any of a variety of well-known references such as a band-gap reference circuit. Amplifier 26 generally is formed as a transconductance amplifier that has impedances connected to amplifier 26 in order to adjust the gain and provide frequency compensation for amplifier 26. Amplifier 26 receives the sense signal (Vs) from output 53 and the reference signal from reference 24 and forms a drive signal that controls a pass element, such as a transistor 70, in order to regulate the value of the output voltage. Regulator 16 may also include an internal operating voltage regulator 21 that provides an internal operating voltage on an output 22 that is used for operating some of the elements of regulator 16 such as operating element 30. Regulator 21 is optional and may not be included in some embodiments.

Those skilled in the art will appreciate that the various elements of regulator 16 have manufacturing variations that could affect the value of the output voltage formed on output 19. For example, amplifier 26 may have an input offset voltage that affects the operation of amplifier 26, or reference 24 may have a reference voltage that deviates from the desired value by a couple of milli-volts, or the gain of transistor 70 may deviate from the desired gain by a couple of percent. Any or all of these manufacturing variations affect the value of the output voltage on output 19. The configuration of network 66 facilitates adjusting the value of the sense signal on output 53 to compensate for these manufacturing variations and other variations such as variations induced during assembly of regulator 16 into a semiconductor package. Any of these variations affect the value of the output voltage formed on output 19.

Programmable feedback network 66 includes a voltage divider that is formed by a coarse adjust resistor 40 connected in series with a fine trim resistor 54 between output 19 and return 18. As will be seen further hereinafter, resistors 40 and 54 provide first and second resistances, R1 and R2 respectively, for the voltage divider to form the sense voltage (Vs). Resistors 40 and 54 are programmable to adjust the value of the first and second resistances (R1 and R2) and the value of the sense signal (Vs) in order to compensate for variations in the value of the output voltage. Network 66 also typically includes a storage element 30 that is utilized to store a control word that assists in selecting the value of the first and second resistances (R1 and R2) of the voltage divider. The control word generally is stored into element 30 from circuitry external to regulator 16 through a data input 27 and a clock input 28. The external data generally is applied to input 27 and a clock signal is applied to input 28 to transfer the data into element 30. Element 30 may be any one of a variety of well known storage elements including a serial to parallel shift register or a non-volatile memory such as a flash EPROM. In other embodiments, the data word may be permanently stored into a ROM or other type of storage device that may be used for element 30.

Resistor 54 includes a fixed resistor 59 (R1F) and a plurality of trim resistors 55-58 that are selectively coupled to be either a portion of the first resistance (R1) or the second resistance (R2) of the resistor divider. Fixed resistor 59 is also labeled as R1F, and the plurality of trim resistors are also labeled as trim resistors R1T1 through R1TM where M represents the number of trim resistors. A plurality of trim switches, such as transistors 61-65, are used to selectively couple output 53 to one of trim resistors 55-58 responsively to the value of the control word within element 30. Resistor 40 includes a fixed resistor 42 (R2F) and a plurality of selectable resistor segments 43-46. Fixed resistor 42 is also labeled as R2F, and the plurality of resistor segments are also labeled as resistor segments R2S1 through R2SN where N represents the number of resistor segments. A plurality of segment switches, such as transistors 48-51, are selectively enabled or disabled responsively to the value of the control word from element 30 in order to couple the resistor segments 43-46 in series with fixed resistor 42.

The value of the output voltage is related to the first and second resistances of the voltage divider and the reference voltage as indicated in the equations shown below:

Vs=Vo(R1/(R2+R2)

thus,

Vo=Vs(1+(R2/R1))

Since regulator 16 controls Vs to be approximately equal to Vref, then:

Vo=Vref(1+(R2/R1))

The above equation illustrates that the value of the output voltage can be adjusted by adjusting the values of the first resistance (R1) and the second resistance (R2) of the voltage divider. The value of the first resistance R1 and the second resistance R2 of the voltage divider are related to the values of resistors 40 and 54 by the equations below:

R1=R1F+R1T(m)

R2=R2F+R2S(n)+R1T(M−m)

Where:
RlF=the value of fixed resistor 59,
RlT=the value of each trim resistor 55-58,
M=the total number of trim resistors 55-58,
m=the number of trim resistors 55-58 that are connected between fixed resistor 59 (R1F) and output 53,
R2F=the value of fixed resistor 42,
R2S=the value of each segment of segments 43-46,
N=the total number of segments 43-46, and
n=the number of segments 43-46 that are not shorted out by transistors 48-51, thus, are connected in series with fixed resistor 42 (R2F).

As can be seen from the equations for R1 and R2 above, a first portion of resistor 54 is used for resistance R1 and the remainder of resistor 54 is used for resistance R2. Enabling more of transistors 48-51 decreases the value of resistance R2, and enabling fewer of transistors 48-51 increases the value of resistance R2. As transistors 61-65 are enabled and disabled to move the position of output 53 from one of trim resistors 55-58 to another, the value of both of R1 and R2 are changed. Moving output 53 toward resistor 40 increases resistance R1 and decreases resistance R2, and moving output 53 toward fixed resistor 59 decreases resistance R1 and increases resistance R2. For example, enabling transistor 62 to couple output 53 to trim resistor 55, forms the first resistance (R1) to have a value that is equal to the value of resistor 59 plus trim resistor 55 and forms the second resistance (R2) to include the value of trim resistors 56, 57, and 58. Thus, the value of R1 and R2 are selectively determined responsively to the value of the control word.

Because the value of the first and second resistances (R1 and R2) of the voltage divider are determined by the control word, then the value of the output voltage is also controlled by the value of the control word as shown by the equation below:

Inserting the equations for R1 and R2 back into the equation for Vo gives:

Vo=Vref(1+((R2F+R2S(n)+R1T(M−m))/(R1F+R1T(m))))

After regulator 16 is assembled into the semiconductor package, a control word can be stored in element 30 and the value of the output voltage can be measured. If the output voltage is not correct, a new control word can be written into element 30 and the output voltage can again be tested. This procedure can be repeated until the desired value of the output voltage is obtained. Once the correct output voltage is obtained, the control word can be kept in element 30.

In the preferred embodiment, POR 23 sets the control word stored in element 30 to a default value that provides a minimum value for the output voltage on output 19. In this preferred embodiment, the default value of the control word enables all of segment transistors 48-51 and connects output 53 of network 66 to the midpoint of the trim resistors of resistor 54. Also in the preferred embodiment, the values of fixed resistors 42 and 59, the value of each segment 43-46, and the value of each trim resistor 55-58 are selected so that each step of trim resistors 55-58 represents a fixed percent of the total value of fixed resistors 42 and 59 plus the value of the number of segments 43-46 that are added to the value of resistor 42. This fixed percentage for each step of trim resistors 55-58 reduces the complexity of determining how to adjust the value of the output voltage.

In one example embodiment, the target value of reference 24 was about 0.6 volts, the target value of the output voltage was about 0.8 volts, fixed resistor 59 was approximately two hundred eight thousand (208,000) ohms, there were thirty two (32) trim resistors, such as trim resistors 55-58, and the value of each trim resistor was approximately two thousand (2000) ohms. The value of fixed resistor 42 was approximately forty eight thousand (48,000) ohms, there were eighty-four (84) resistor segments, such as resistor segments 43-46, and the value of each resistor segment was approximately twenty thousand (20,000) ohms. The default value of the control word enabled all of 84 of the segment transistors, such as transistors 48-51, and enabled the middle transistor of the trim transistors such as transistors 61-65. This default condition provided the values shown below for resistances R1 and R2 of the resistor divider:

R1=R1F+R1T(m)=208,000+2,000(16)=240,000 ohms

R2=R2F+R2S(n)+R1T(M−m)=48000+20000(0)+2000(16)=80,000 ohms

Where:
M=32,
m=16,
R2F=208,000 ohms,
R2S=20,000 ohms,
N=84, and
n=0.

The resulting value of the output voltage on output 19 was:

$$\begin{matrix}Vo = Vref ( 1 + ( ( R 2 F + R2S ( 0 ) + \\ R 1 T ( 16 ) ) / ( R 1 F + R 1 T ( 16 ) ) ) ) \\ = 0.605 ( 1 + ( 80 / 240 ) ) \\ = 0.605 ( 1.333 ) \\ = 0.8066\end{matrix}$$

Although coarse adjust resistor 40 is described with all resistors 43-46 having equal values, in the preferred embodiment resistors 43-46 all have different values. Using different values for each of resistors 43-46 assists in providing greater flexibility in making the coarse adjustments of the resistor and corresponding output voltage values. In this preferred embodiment, the value of the resistor resulting from the non-shorted resistors of resistors 43-46 is a summation of the non-shorted resistor values. For example, resistor 43 may have a value of twenty thousand ohms, resistor 44 may have a value of forty thousand ohms, resistor 45 may have a value of seventy thousand ohms, etc. In order to adjust the value of the output voltage to the desired target value, a control word was written into element 30 that increased the number of trim resistors in the first resistance R1 by enabling the next greater trim transistor that moves output 53 up one trim resistor in resistor 54 thereby changing the value of both R1 and R2 as shown below:

$$\begin{matrix}Vo = Vref ( 1 + ( ( R 2 F + R 2 S ( 0 ) + R 1 T ( 15 ) ) / \\ ( R 1 F + R 1 T ( 17 ) ) ) ) \\ = 0.605 ( 1 + ( 48 K + 20 K ( 0 ) + 2 K ( 15 ) / \\ ( 208 K + 2 K ( 17 ) ) ) ) \\ = 0.605 ( 1 + ( 78 / 242 ) ) \\ = 0.605 ( 1.32231 ) \\ = 0.8 .\end{matrix}$$

As can be seen, the smaller values of trim resistors 55-58 provide for fine adjustments and the larger values of segments 43-46 provide coarse adjustments for adjusting the value of the output voltage.

In order to facilitate this functionality for regulator 16, a first terminal of resistor 40 is connected to output 19 and to a first terminal of resistor 42. A second terminal of resistor 42 is commonly connected to a drain of transistor 48 and a first terminal of resistor segment 43. A second terminal of resistor segment 43 is commonly connected to a drain of transistor 49 and a first terminal of resistor 44. A second terminal of resistor 44 is commonly connected to a drain of transistor 50 and a first terminal of resistor 45. A second terminal of resistor 45 is commonly connected to a drain of transistor 51 and a first terminal of resistor 46. A second terminal of resistor 46 is commonly connected to a source of transistor 51, a source of transistor 50, a source of transistor 49, a source of transistor 48, a source of transistor 65, and a first terminal of resistor 58. A second terminal of resistor 58 is commonly connected to a first terminal of resistor 57 and a source of transistor 64. A second terminal of resistor 57 is commonly connected to a source of transistor 63 and a first terminal of resistor 56. A second terminal resistor 56 is commonly connected to a source of transistor 62 and a first terminal of resistor 55. A second terminal of resistor 55 is commonly connected to a source of transistor 61 and a first terminal of resistor 59. A second terminal of resistor 59 is connected to a second terminal of resistor 54 and to return 18. A drain of transistor 61 is commonly connected to output 53, to a non-inverting input of amplifier 26, a drain of transistor 62, a drain of transistor 63, a drain of transistor 64, and a drain of transistor 65. A gate of transistor 61 is connected to a first output of element 30, a gate of transistor 62 is connected to a second output from element 30, a gate of transistor 63 is connected to a third output of element 30, a gate of transistor 64 is connected to a fourth output of element 30 and a gate of transistor 65 is connected to a fifth output of element 30. A gate of transistor 51 is connected to a sixth output of element 30, a gate of transistor 50 is connected to a seventh output of element 30, a gate of transistor 49 is connected to an eighth output of element 30, and a gate of transistor 48 is connected to a ninth output of element 30. An inverting input of amplifier 26 is connected to an output of reference 24. The output of amplifier 26 is connected to the gate of transistor 70 which has a drain connected to output 19 and source connected to input 17.

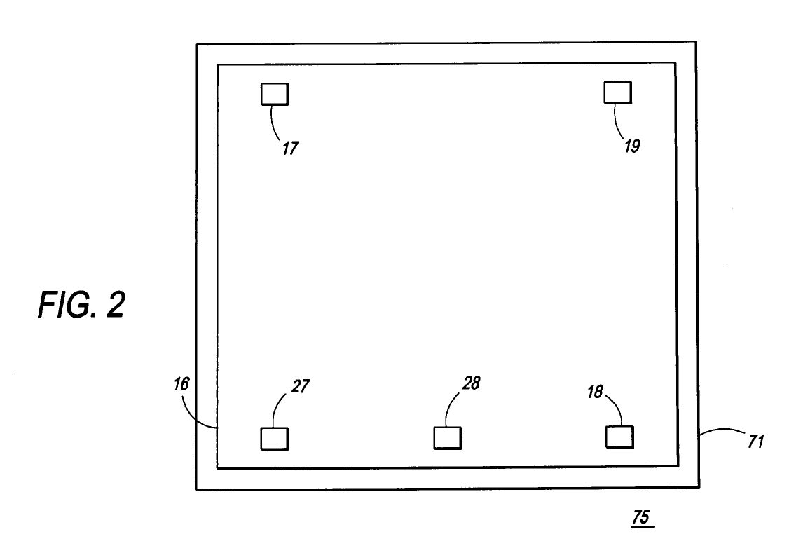

FIG. 2 schematically illustrates an enlarged plan view of a portion of an embodiment of a semiconductor device or integrated circuit 75 that is formed on a semiconductor die 71. Regulator 16 is formed on die 71. Die 71 may also include other circuits that are not shown in FIG. 2 for simplicity of the drawing. Regulator 16 and device or integrated circuit 75 are formed on die 71 by semiconductor manufacturing techniques that are well known to those skilled in the art. In one embodiment, regulator 16 is formed on a semiconductor substrate as an integrated circuit having five external leads, such as input 17, return 18, output 19, and inputs 27 and 28, and assembled into a semiconductor package having six leads or terminals.

In view of all of the above, it is evident that a novel device and method is disclosed. Included, among other features, is forming a programmable feedback network that adjusts the value of the output voltage. Programming the value of the feedback network also programs the sense signal transfer function that relates the sense signal (Vs) to the output voltage. Programming the sense signal transfer function facilitates compensating the voltage regulator for variations in the value of the elements of the regulator including variations resulting from manufacturing tolerances and variations induced during the assembly of the regulator into a final package.

While the subject matter of the invention is described with specific preferred embodiments, it is evident that many alternatives and variations will be apparent to those skilled in the semiconductor arts. For example, the first and second resistance may be reversed, or the effects of the switches may be reversed so that switches may be disabled to add or subtract resistive elements. Although the method is described for certain N-channel MOS transistors, the method is directly applicable to other transistors such as, MOS, BiCMOS, metal semiconductor FETs (MESFETs), HFETs, and other transistor structures. Additionally, the word “connected” is used throughout for clarity of the description, however, it is intended to have the same meaning as the word “coupled”. Accordingly, “connected” should be interpreted as including either a direct connection or an indirect connection.

1. A feedback network for a voltage regulator comprising:
an input to the feedback network;
a common return of the feedback network;
a first resistor;
a second resistor connected in series with the first resistor, the second resistor having a plurality of series connected trim resistors; and
an output of the feedback network configured to be selectively coupled to one of the plurality of series connected trim resistors thereby selectively coupling a first portion of the plurality of series connected trim resistors in series with the first resistor between the output and the input and thereby also selectively coupling a second portion of the plurality of series connected trim resistors between the output and the common return.

2. The feedback network of claim 1 wherein the second resistor includes a fixed resistor coupled in series with the plurality of series connected trim resistors wherein a value of the second resistor includes the fixed resistor plus the second portion of the plurality of series connected trim resistors that does not include the first portion of the plurality of series connected trim resistors.

3. The feedback network of claim 1 wherein the output of the feedback network is selectively coupled to one of the plurality of series connected trim resistors responsively to a control word received from externally to the voltage regulator.

4. The feedback network of claim 3 further including a plurality of trim switches with a trim switch of the plurality of trim switches coupled between each trim resistor and the output of the feedback network, the plurality of trim switches configured to be individually enabled responsively to the control word.

5. The feedback network of claim 1 wherein the first resistor includes a fixed resistor coupled in series with a plurality of resistor segments that are selectively coupled in series with the fixed resistor wherein a value of the first resistor includes the fixed resistor plus a first portion of the plurality of resistor segments plus the first portion of the plurality of series connected trim resistors.

6. The feedback network of claim 5 wherein a portion of the plurality of resistor segments are selectively coupled in series with the fixed resistor responsively to a control word received from externally to the voltage regulator.

7. The feedback network of claim 6 further including a plurality of segment switches with a segment switch of the plurality of segment switches coupled in parallel with each resistor segment, the plurality of segment switches configured to be individually enabled responsively to the control word.

8. A method of forming a voltage regulator comprising:
configuring the voltage regulator to form an output voltage having a value; and
configuring a programmable feedback network to include a first resistor having a first value and a second resistor having a second value wherein the first value and the second value are selectively formed responsively to a control word and wherein changing the first value by a first amount changes the second value by the same amount but in an opposite direction.

9. The method of claim 8 wherein configuring the programmable feedback network includes configuring the programmable feedback network to receive the control word from external to the voltage regulator.

10. The method of claim 8 wherein configuring the programmable feedback network includes coupling an output of the programmable feedback network to be selectively coupled to a first trim resistor of a plurality of series connected trim resistors.

11. The method of claim 10 wherein the step of coupling the output to the first trim resistor couples a first portion of the plurality of trim resistors in series to form the first value and couples a second portion of the plurality of trim resistors to the second resistor.

12. The method of claim 10 wherein configuring the programmable feedback network includes configuring the second resistor to include a plurality of resistor segments that are selectively coupled in series with the second resistor responsively to the control word.

13. The method of claim 12 wherein configuring the second resistor to include the plurality of resistor segments includes coupling a transistor in parallel with a resistor to form a resistor segment wherein the transistor is enabled and disabled responsively to the control word.

14. A programmable voltage divider comprising:
a first resistor;
a first transistor coupled in parallel with the first resistor and configured to be selectively enabled responsively to a control word;
a second resistor coupled in series with the first resistor;
a second transistor having a first current carrying electrode coupled to the second resistor and a second current carrying electrode coupled to an output of the programmable voltage divider and a control electrode configured to selectively enable the second transistor responsively to the control word;
a third resistor coupled in series with the second resistor; and
a third transistor having a first current carrying electrode coupled to the third resistor, a second current carrying electrode coupled to the output of the programmable voltage divider, and a control electrode configured to selectively enable the third transistor responsively to the control word.

15. The programmable voltage divider of claim 14 further including a first fixed resistor coupled in series with the first resistor.

16. The programmable voltage divider of claim 15 further including a second fixed resistor coupled in series with the third resistor.

17. The programmable voltage divider of claim 14 further including a storage element configured to receive the control word from external to the programmable voltage divider and to store the control word in the storage element.

18. The programmable voltage divider of claim 14 further including a fourth resistor coupled in series with the first resistor and a fourth transistor coupled in parallel with the fourth resistor.
